(19) United States
(12) Patent Application Publication
(10) Pub. No.: US 2009/0045748 A1
(43) Pub. Date: Feb. 19, 2009

(54) Emergency Lighting Structure

(76) Inventor: Jeng-Hwang YOU, Su Ao Chen (TW)

Correspondence Address: LEONG C LEI, PMB # 1008, 1867 YGNACIO VALLEY ROAD, WALNUT CREEK, CA, 94598, US

(21) Appl. No.: 12/191,318

(22) Filed: Aug. 14, 2008

(30) Foreign Application Priority Data
Aug. 14, 2007 (TW) 096213359

(51) Int. Cl. H05B 37/00

(52) U.S. Cl. 315/86

(57) ABSTRACT

An emergency lighting structure is disclosed. The lighting structure employs high brightness LED as light source supply and dry cells are used to provide current during emergency. A plug is secured to a socket and when AC is interrupted, a current detection unit detects the interruption to trigger the power of the dry cells. When the dry cells are exhausted, a capacitance detection unit detects the status of current supply to trigger flashing which is controlled by a flash control unit.

### BACKGROUND OF THE INVENTION

(a) Technical Field of the Invention

The present invention relates to emergency lighting structure, and in particular, a lighting structure employing LED as light source.

(b) Description of the Prior Art

Emergency lightings are used in public places, such as corridors, passage way, staircases such that if AC supply is interrupted, the emergency lighting will provide lights, such that sufficient time is provided for escaping or leaving the place.

LED technology is matured and is utilized in everyday life. High brightness LED may be used to replace existing lighting system for the reason that the light source of LED is longer than that of the light bulbs. Conventional light bulbs do not provide bright intensity light source while LED, as a result of its single wavelength, provides more focus light. Further, LED has limited space with excellent longevity, low voltage, low current.

Conventional emergency lighting structure requires great number of dry cells and therefore the structure is generally too bulky.

In view of the above, it is an object of the present invention to provide an emergency lighting structure, which makes use of high brightness LED to provide light.

### SUMMARY OF THE INVENTION

The primary purpose of the present invention is to provide an emergency lighting structure comprising at least one high brightness LED mounted at the main body of the lighting structure to provide lighting source; a plug provided on the main body of the lighting structure for connecting the main body of the lighting structure and the AC supply socket a current source detection unit mounted on the main body of the emergency lighting structure to detect the status of the AC supply; a current control unit mounted on the main body of the emergency lighting structure for controlling the triggering of dry cells current supply; a capacitance detection unit mounted on the main body of the emergency lighting structure for detection of capacitance of dry cells; a flash control unit mounted on the main body of the emergency lighting structure to control the triggering of high brightness LED to produce light source by way of flashing, characterized in that the dry cells are provided at the main body of the emergency lighting structure which are connected to the AC supply socket via connector such that when AC is interrupted, the current source detection unit drives the current source control unit to trigger the power source of the dry cells, the dry cells are detected by way of the capacitance detection unit, and when the capacitance is normal, high brightness LED continuously generates light source, and when the capacitance is too low, the flash control unit is driven such that the high brightness LED generates flashes as light source.

Yet still another object of the present invention is to provide an emergency lighting structure, wherein the specification of the dry cells matches the specification of the emergency lighting structure.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIGS. 2-8 illustrate perspective views of the emergency lighting structure in accordance with the present invention.

FIG. 9 schematically illustrates the wiring structure of the emergency lighting structure of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

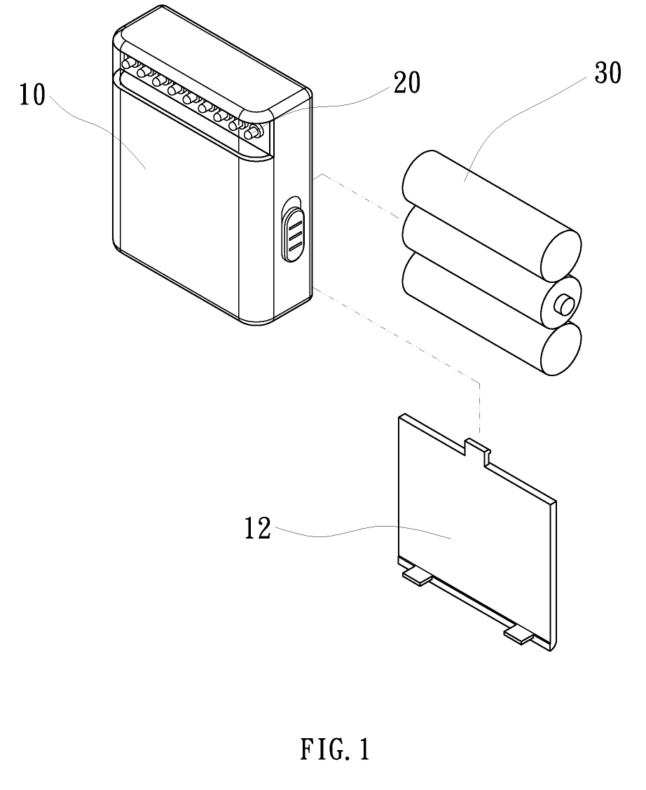

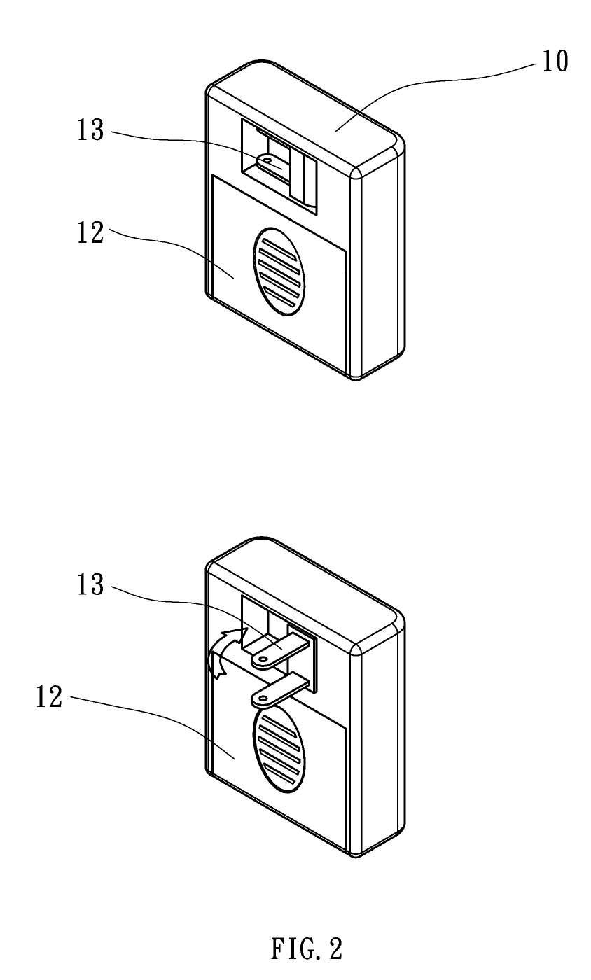

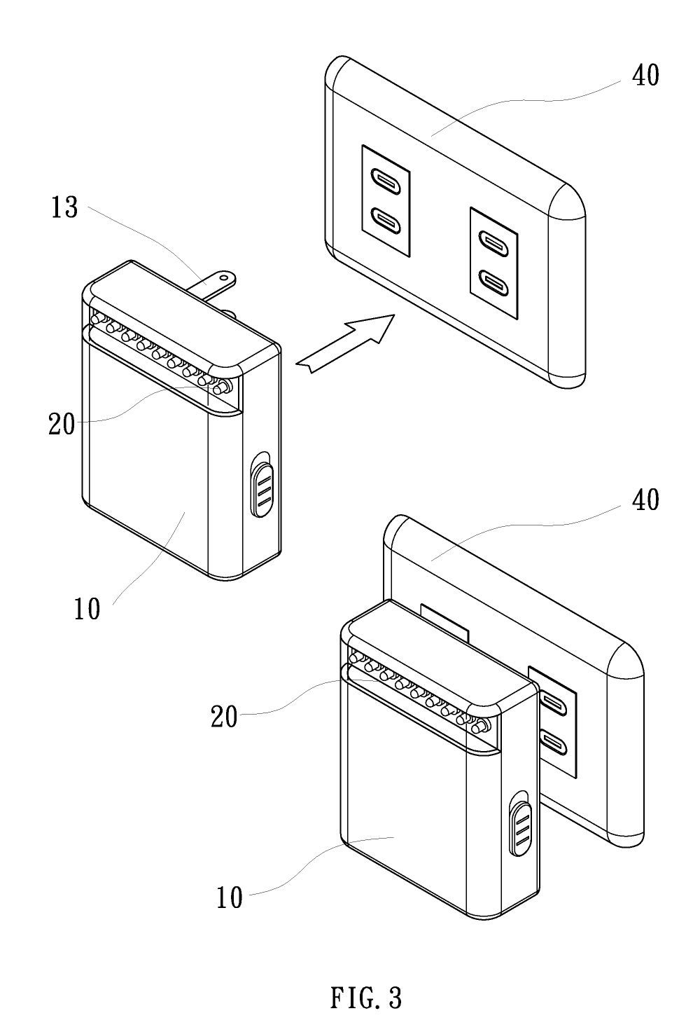

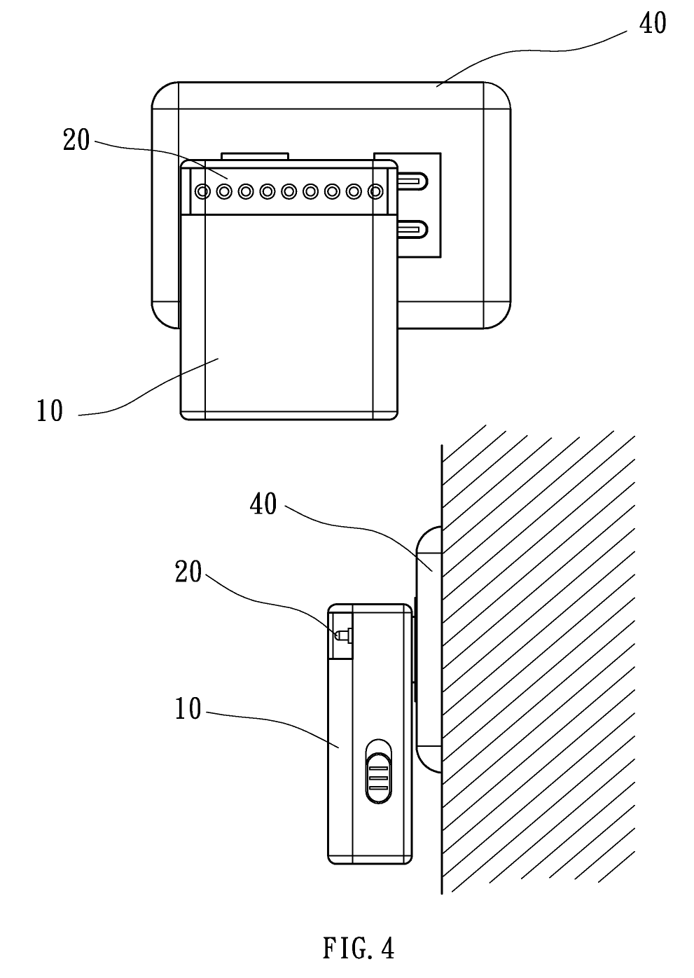

Referring to FIGS. 1 to 4, there is shown an emergency lighting structure comprising a main body 10, a dry cell cover 12, a plug 13, high brightness LED 20, current detection unit 50, current control unit 60, capacitance detection unit 70 and flash control unit 80.

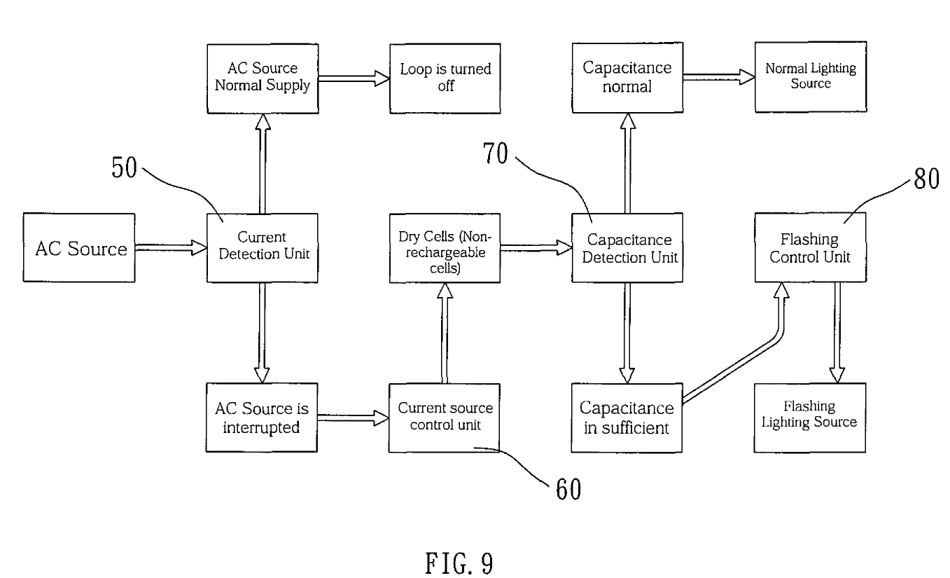

As shown in FIGS. 1 to 4 and 9, the emergency light main body 10 is mounted with dry cells 30, the dry cell cover 12 capped the dry cell and the plug 13 connected to the AC supply socket. When AC supply is normal and the emergency light main body 10 is linked to the AC supply socket 40, the current detection unit 50 detects the loop as a closed loop. When AC supply is interrupted, or the emergency lighting structure body 10 is detached from the AC supply socket 40, the current detection unit 50 is detected and drives the current control unit 60 to change the use of the dry cell as light source. When the capacitance detect unit 70 detects the capacitance as normal, a high brightness LED 20 generates normal light signal. When current is interrupted or AC supply cannot be supplied normally, as the above where the current is detected as low by the capacitance detection unit 70, the flash control unit 80 is triggered to flash such that the high brightness LED 20 generates a flashing signal as a warning to replace with new dry cells.

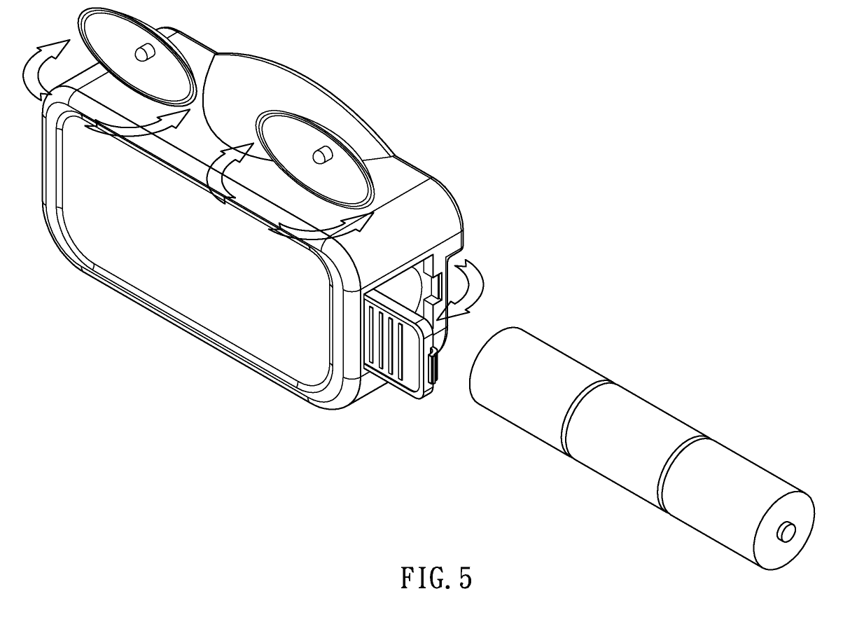

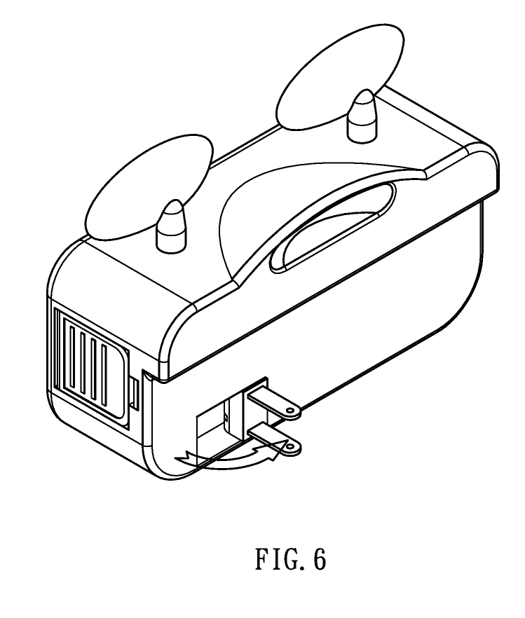

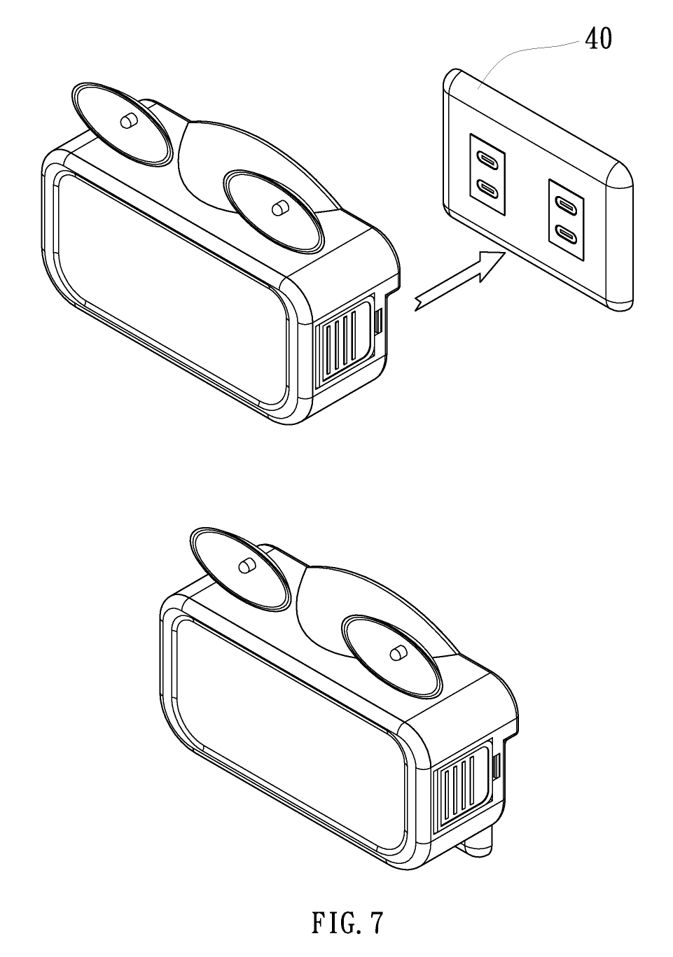

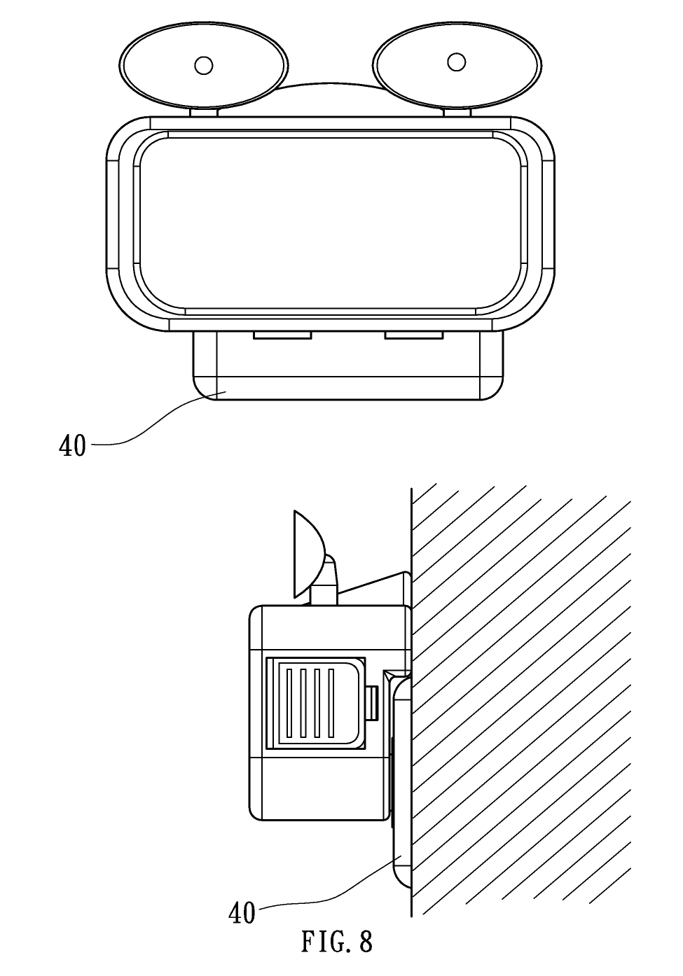

Referring to FIGS. 5-9, the emergency lighting structure can be provided with dry cell 35 of different sizes depending on the space for lighting.

In accordance with the present invention, dry cells 30 are used to substitute are chargeable batteries. It is used only when AC cannot be supplied to the emergency lighting structure. Thus, the temperature of the battery and the lighting structure will not be high and therefore the longevity of the lighting structure is extended.

When the capacitance of the dry cell 30 is insufficient, the capacitance detection unit 70 will match with the flash control unit 80 such that the high brightness LED will generate a flashing signal as a warning indication. It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An emergency lighting structure comprising at least one high brightness LED mounted at the main body of the lighting structure to provide lighting source;
a plug provided on the main body of the lighting structure for connecting the main body of the lighting structure and the AC supply socket;
a current source detection unit mounted on the main body of the emergency lighting structure to detect the status of the AC supply;
a current control unit mounted on the main body of the emergency lighting structure for controlling the triggering of dry cells current supply;
a capacitance detection unit mounted on the main body of the emergency lighting structure for detection of capacitance of dry cells;
a flash control unit mounted on the main body of the emergency lighting structure to control the triggering of high brightness LED to produce light source by way of flashing,
characterized in that the dry cells are provided at the main body of the emergency lighting structure which are connected to the AC supply socket via connector such that when AC is interrupted, the current source detection unit drives the current source control unit to trigger the power source of the dry cells, the dry cells are detected by way of the capacitance detection unit, and when the capacitance is normal, high brightness LED continuously generates light source, and when the capacitance is too low, the flash control unit is driven such that the high brightness LED generates flashes as light source.

2. The emergency lighting structure of claim 1, wherein the specification of the dry cells matches the specification of the emergency lighting structure
